(19) United States
(12) Patent Application Publication
(10) Pub. No.: US 2007/0177262 A1
(43) Pub. Date: Aug. 2, 2007

(54) RESIN SHEET FOR TRANSMISSIVE SCREEN

(75) Inventors: Tomohiro Maekawa, Niihama-shi (JP); Katsumi Akada, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/610,097

(22) Filed: Dec. 13, 2006

(30) Foreign Application Priority Data
Dec. 14, 2005 (JP) 2005-360099
Dec. 16, 2005 (JP) 2005-362803

(51) Int. Cl. G03B 21/60

(52) U.S. Cl. 359/457

(57) ABSTRACT

The present invention provides a transmissive screen having as a member an extruded resin sheet (A) obtained by extrusion of a transparent resin (P) in a heat melt state from a die (D) in one direction, and provides a transmissive screen, wherein in the case where the extruded resin sheet (A) is subjected to a heating test of maintaining the resin sheet at 150° C. for 1 hour, the shrinkage factor (S) in the extrusion direction evaluated from Equation (1):
S=(L₀−L₁)/L₀×100 (1)
wherein S represents the shrinkage factor (%) in the extrusion direction, L₀ represents the length (mm) in the extrusion direction prior to the heating test, and L₁ represents the length (mm) in the extrusion direction after the heating test, satisfies Equation (2):
2/X≦S≦18/X (2) wherein S means the same as S in Equation (1), and X represents the sheet thickness (mm) of the extruded resin sheet (A).

### BACKGROUND OF THE INVENTION

1. Field of the Invention

The present invention relates to a transmissive screen. The present invention also relates to a process for producing an extruded resin sheet and specifically relates to a process for producing an extruded resin sheet by extruding a thermoplastic resin in a heat melt state from a die, winding and passing the resin through a cooling roll to cool the resin.

2. Description of the Related Art

As shown in FIG. 1, a rear projection type display apparatus (5), sometimes called as a projection television, which includes a transmissive screen (3) and a projector (4) having disposed on the back side thereof and shows an image projected from the projector (4) for display has been widely used.

As the transmissive screen (3) used in the rear projection type display apparatus (5), it is generally used a two-sheet type in which the screen respectively has a Fresnel lens sheet (11) disposed on the back side of a sheet, in which light (L) from the projector (4) is put, and a lenticular lens sheet (12) disposed on the front side of the other sheet, from which this light (L) outgoes (US2005/0213208A1). In addition, as the projector (4), an LCD projector, in which a liquid crystal cell (not shown) and a polarizing plate (not shown) disposed on both sides of the liquid crystal cell form and project an image, has recently been widely used.

The Fresnel lens sheet (11) is a sheet, for example, having a Fresnel lens layer (11a) formed on the surface of the front of a transparent base sheet (A1) thereof. The Fresnel lens layer (11a) is formed, for example as shown in FIG. 4, by a method of forming a curing resin layer made of a curing resin, having a surface shape of a target Fresnel lens, on the surface of the front side of the transparent base sheet (A1), and then curing this curing resin layer.

The lenticular lens sheet (12) is a sheet, for example, having a lenticular lens film (12b) laminated on the surface of the rear side of a transparent base sheet (A2) thereof, and having a hard coat layer (12a) for preventing being scratched formed on the surface of the front side thereof. The hard coat layer (12a) is formed, for example as shown in FIG. 5, by applying a hard coating agent onto the surface of the front side of the transparent base sheet (A2) and curing the coating agent.

Here, as the hard coating agent and the curing resin constituting the curing resin layer are used an ultraviolet-ray curing substance curable by irradiating with an ultraviolet ray, and a thermosetting substance curable by heating.

As transparent base sheets (A1, A2) constituting the Fresnel lens sheet (11), the lenticular lens sheet (12) and the like are used, for example as shown in FIGS. 2 and 3, an extruded resin sheet (A) obtained by extrusion of a transparent resin (P) in a heat melt state from a die (D) in one direction in terms of productivity.

A process for producing an extruded resin sheet by extruding a thermoplastic resin in a heat melt state from a die, for example as disclosed in JP-A-1-235623 and shown in FIGS. 2 and 3, involves
(1) extruding the thermoplastic resin in a heat melt state from the die (1),
(2) nipping the thermoplastic resin in between a first cooling roll (R1) and a second cooling roll (R2) and winding the resin on the second cooling roll (R2), and then
(3-1) winding the resin on one lattercooling roll (R3) (FIG. 2), or
(3-2) winding the resin on a plurality of latter cooling rolls (R3, R4 . . . ) one after another (FIG. 3) to cool the resin,
(4) further cooling the resin while maintaining the resin in a flat state to solidify, and
(5) withdrawing the resin by means of a pair of take-off rolls (N1, N2).

In the document just cited above, the peripheral speed (Vₙ) of the take-off rolls (N1, N2) is not described. However, in the conventional process, the take-off rolls (N1, N2) are rotated in such a way that the peripheral speed (Vₙ) is substantially the same as the average peripheral speed (V₁₂) of the first cooling roll (R1) and the second cooling roll (R2), and then the solidified thermoplastic resin (Pt) is withdrawn.

However, an extruded resin sheet (A) obtained by such a conventional process had a problem of tending to warp when a single side of the sheet is exposed to an ultraviolet ray or a heat ray.

Additionally, transparent base sheets (A1, A2) comprising the extruded resin sheet (A) that have been conventionally used cause a problem of being prone to be distorted when they are irradiated with an ultraviolet ray or heated for the purpose of formation of a Fresnel lens layer (11a) or a hard coat layer (12a). Moreover, the use of an LCD projector as the projector (4) also causes a problem of being apt to color-drift.

### SUMMARY OF THE INVENTION

An object of the present invention is to provide a transmissive screen that has an extruded resin sheet (A) as a member and can give a non-color-drifted image even when an LCD projector is used as the projector (4), wherein the extruded resin sheet (A) can be used as the transparent base sheets (A1, A2) constituting a Fresnel lens sheet (11) or a lenticular lens sheet (12) and hardly distorted even though it is irradiated with an ultraviolet ray or heated in order to form a Fresnel lens layer (11a) or a hard coat layer (12a). Moreover, another object of the present invention is to provide a process that enables production of an extruded resin sheet (A) that is hardly warped even when a single side of the sheet is exposed to an ultraviolet ray or a heat ray.

The present invention provides a transmissive screen having as a member an extruded resin sheet (A) obtained by extrusion of a transparent resin (P) in a heat melt state from a die (D) in one direction, and provides a transmissive screen, wherein in the case where the extruded resin sheet (A) is subjected to a heating test of maintaining the resin sheet at 150° C. for 1 hour, the shrinkage factor (S) in the extrusion direction evaluated from Equation (1):
S=(L₀−L₁)/L₀×100 (1)
wherein S represents the shrinkage factor (%) in the extrusion direction. L₀ represents the length (mm) in the extrusion direction prior to the heating test, and L₁ represents the length (mm) in the extrusion direction after the heating test, satisfies Equation (2):
2/X≦S≦18/X (2)
wherein S means the same as S in Equation (1), and X represents the sheet thickness (mm) of the extruded resin sheet (A).

In addition, the present invention provides a process for producing an extruded resin sheet (A) comprising:
extruding a thermoplastic resin from a die (1) in a heat melt state,
nipping the resin in between a first cooling roll (R1) and a second cooling roll (R2), winding the resin on the second cooling roll (R2), and then
winding the resin on one lattercooling roll (R3), or winding the resin on a plurality of lattercooling rolls (R3, R4 . . . ) one after another to cool the resin, and then
further cooling the resin while maintaining the resin in a flat state to solidify, and subsequently
withdrawing the resin by means of a pair of take-off rolls (N1, N2), wherein
the peripheral speed (V₃) of the above one lattercooling roll (R3) or the average peripheral speed (V₃ₐ) of the above plurality of the lattercooling rolls (R3, R4 . . . ) is made to be 0.94 times to 1.03 times the average peripheral speed (V₁₂) of the above first cooling roll (R1) and the above second cooling roll (R2), the average peripheral speed (Vₙ) of the above pair of the take-off rolls (N1, N2) is made to be 0.95 times to 1.03 times the peripheral speed (V₃) of the above one lattercooling roll (R3) or the average peripheral speed (V₃ₐ) of the above plurality of the lattercooling rolls (R3, R4 . . . ), and
the average peripheral speed (Vₙ) of the above pair of the take-off rolls (N1, N2) is made to be 0.95 times to 0.995 times the average peripheral speed (V₁₂) of the above first cooling roll (R1) and the above second cooling roll (R2).

An extruded resin sheet (A), which the transmissive screen of the present invention has as a member, does not tend to be distorted even though the sheet is irradiated with ultraviolet ray or heated for the purpose of formation of a Fresnel lens layer (11a) or a hard coat layer (12a) on the surface thereof. In addition, a transmissive screen (3) comprising a Fresnel lens sheet (11) having the extruded resin sheet (A) used as a transparent base sheet (A1) and having a Fresnel lens sheet layer (11a) formed on the surface of the front side thereof and a lenticular lens sheet (12) having the extruded resin sheet (A) used as a transparent base sheet (A2) and having a hard coat layer (12a) formed on the surface of the front side thereof can display a non-color-drifted image even when an image is projected from an LCD projector (4). Moreover, the extruded resin sheet (A) obtained by the process of the present invention is hardly warped even when a single side of the sheet is exposed to an ultraviolet ray or a heat ray.

### BRIEF DESCRIPTION OF THE DRAWINGS

FIG. 1 is a sectional view schematically indicating the structure of a rear projection type display apparatus and its transmissive screen.

FIG. 2 is a schematic diagram indicating an example of a process for producing an extruded resin sheet (A) by extruding a thermoplastic resin in a heat melt state from a die (1).

FIG. 3 is a schematic diagram indicating an example of a process for producing an extruded resin sheet (A) by extruding a thermoplastic resin in a heat melt state from a die (1).

FIG. 4 is a schematic diagram indicating a step of producing a Fresnel lens sheet (11) using the extruded resin sheet (A) as a transparent base sheet (A1).

FIG. 5 is a schematic diagram indicating a step of producing a lenticular lens sheet (12) using the extruded resin sheet (A) as a transparent base sheet (A2).

A, A1, A2: an extruded resin sheet (a transparent base sheet)

P, P0, P1, P2, P3, P4, Pr, Pt: a thermoplastic resin (a transparent resin)

1: a die

2: an extruder

R1: a first cooling roll

R2: a second cooling roll

R3: a lattercooling roll

R4: a lattercooling roll

Rt: delivering rollers

Tr: a roller table

N1, N2: a take-off roll

3: a transmissive screen

4: a projector

4l: a mirror

5: a rear projection type display apparatus

L: light

11: a Fresnel lens sheet

11a: a Fresnel lens layer

11a′: a curable resin layer

12: a lenticular lens sheet

12a: a hard coat layer

12a′: a hard coating agent layer

12b: a lenticular lens film

12b′: a lenticular lens film

### DETAILED DESCRIPTION OF THE INVENTION

The extruded resin sheet (A) as a member of the transmissive screen of the present invention is obtained by the extrusion of a transparent resin (P) in a heat melt state from a die (D) in one direction.

As the transparent resin (P) a thermoplastic resin is normally utilized and may be, for example, a general-purpose thermoplastic resin or engineering plastics. The examples include methacrylic resins, styrene resins, methyl methacrylate-styrene resins, polyvinyl chloride resins, polyethylene resins such as low density polyethylene, high density polyethylene and linear low density polyethylene, polypropylene resins, acrylonitrile-butadiene-styrene resins, acrylonitrile-styrene resins, cellulose acetate resins, ethylene-vinyl acetate resins, acryl-chlorinated polyethylene resins, ethylene vinyl alcohol resins, fluorine resins, polyacetal resins, polyamide resins, polyethylene terephthalate resins, polybutylene terephthalate resins, aromatic polycarbonate resins, polysulfone resins, polyether sulfone resins, methylpentene resins, polyarylate resins, resins containing an alicyclic structure-containing ethylenic unsaturated monomer units, and the like.

The transparent resin (P) may be a thermoplastic elastomer and the examples thereof also include polyvinyl chloride-based elastomers, chlorinated polyethylenes, ethylene-ethyl acrylate resins, thermoplastic polyurethane elastomers, thermoplastic polyester elastomers, ionomer resins, styrene/butadiene block polymers, ethylene-propylene rubber, polybutadiene resins, acrylic elastomers, and the like.

In order to obtain an extruded resin sheet (A) having good optical characteristics, methacrylic resins, styrene resins, aromatic polycarbonate resins, resins containing an alicyclic structure-containing ethylenic unsaturated monomer unit, or the like are preferably used as the transparent resin (P).

As a methacrylic resin, for example, a methacrylic resin having a methyl methacrylate unit as a main component is used. Specifically, a methyl methacrylate resin containing normally 50 mass % or more, preferably 70 mass or more of a methyl methacrylate unit is preferably used. Examples of the methyl methacrylate resin include, for example, in addition to methyl methacrylate single polymer of 100 mass % of a methyl methacrylate unit, copolymers of methyl methacrylate and an other monomer capable of copolymerizing therewith, and the like.

Examples of the other monomer capable of copolymerizing with methyl methacrylate include, for example, methacrylate esters other than methyl methacrylate such as ethyl methacrylate, butyl methacrylate, cyclohexyl methacrylate, phenyl methacrylate, benzyl methacrylate, 2-ethylhexyl methacrylate, and 2-hydroxyethyl methacrylate,

Examples of the other monomer also include acrylate esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate.

Examples of the other monomer further include, for example, unsaturated acids such as methacrylic acid and acrylic acid, halogenated styrenes such as chlorostyrene and bromostyrene, substituted styrenes such as alkyl styrenes such as vinyl toluene and α-methyl styrene, acrylonitrile, methacrylonitrile, maleic anhydride, phenyl maleimide, and cyclohexyl maleimide.

These other monomers capable of copolymerizing with methyl methacrylate may each be used alone or in combination of two or more species.

The styrene resins may be resins having a styrene-based single functional monomer unit as a main component such as, for example, a resin containing 50 mass % or more of a styrene-based monomer unit, which may comprise 100 mass % of a styrene-based single functional monomer, or may be a copolymer of a styrene-based single functional monomer and a single functional monomer capable of copolymerizing therewith.

The styrene-based single functional monomer is a compound having a styrene skeleton and one double bond capable of radical polymerization within the molecule such as substituted styrenes. Examples of the styrene-based single functional monomer include, for example, styrene, halogenated styrenes such as chlorostyrene and bromostyrene, vinyl toluene and alkyl styrenes such as α-methyl styrene. Each of the styrene-based single functional monomers is used alone or in combination of two or more species.

A single functional monomer capable of copolymerizing with a styrene-based single functional monomer is a compound having one double bond capable of radical polymerization within the molecule and being capable of copolymerizing with a styrene-based single functional monomer by means of the double bond. The examples include methacrylic acid esters such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate, acrylic acid esters such as methyl acrylate, ethyl acrylate, butyl acrylate, cyclohexyl acrylate, phenyl acrylate, benzyl acrylate, 2-ethylhexyl acrylate and 2-hydroxyethyl acrylate, acrylonitrile, and the like; among them, methacrylic acid esters are preferably used, and methyl methacrylate is more preferably used. Each of such single functional monomers is used alone, or in combination of two or more species.

Examples of the aromatic polycarbonate resins include, for example, in addition to resins obtained by the reaction of a bivalent phenol with a carbonate precursor by means of an interfacial polycondensation method or a melt ester exchange method, resins obtained by polymerization of a carbonate prepolymer by means of a solid phase ester exchange method, resins obtained by polymerization of a cyclic carbonate compound by means of a ring opening polymerization method, and the like.

Examples of the bivalent phenols include, for example,
hydroquinone,
resorcinol,
4,4′-dihydroxydiphenyl,
bis(4-hydroxyphenyl)methane,
bis{(4-hydroxy-3,5-dimethyl)phenyl}methane,
1,1-bis(4-hydroxyphenyl)ethane,
1,1-bis(4-hydroxyphenyl)-1-phenylethane,
2,2-bis(4-hydroxyphenyl)propane (common name, bisphenol A),
2,2-bis{(4-hydroxy-3-methyl)phenyl}propane,
2,2-bis{(4-hydroxy-3,5-dimethyl)phenyl}propane,
2,2-bis{(4-hydroxy-3,5-dibromo)phenyl}propane,
2,2-bis{(3-isopropyl-4-hydroxy)phenyl}propane,
2,2-bis{(4-hydroxy-3-phenyl)phenyl}propane,
2,2-bis(4-hydroxyphenyl)butane,
2,2-bis(4-hydroxyphenyl)-3-methylbutane,
2,2-bis(4-hydroxyphenyl)-3,3-dimetylbutane,
2,4-bis(4-hydroxyphenyl)-2-methylbutane,
2,2-bis(4-hydroxyphenyl)pentane,
2,2-bis(4-hydroxyphenyl)-4-methylpentane,
1,1-bis(4-hydroxyphenyl)cyclohexane,
1,1-bis(4-hydroxyphenyl)-4-isopropylcyclohexane,
1,1-bis(4-hydroxyphenyl)-3,3,5-trimetylcyclohexane,
9,9-bis(4-hydroxyphenyl)fluorene,
9,9-bis(4-hydroxy-3-methyl)phenyl}fluorene,
α,α′-bis(4-hydroxyphenyl)-o-diisopropylbenzene,
α,α′-bis(4-hydroxyphenyl)-m-diisopropylbenzene,
α,α′-bis(4-hydroxyphenyl)-p-diisopropylbenzene,
1,3-bis(4-hydroxyphenyl)-5,7-dimethyladamantane,
4,4′-dihydroxydiphenylsulfone,
4,4′-dihydroxydiphenylsulfoxide,
4,4′-dihydroxydiphenylsulfide,
4,4′-dihydroxydiphenylketone,
4,4′-diphydroxydiphenyl ether,
4,4′-dihydroxydiphenyl ester, and
   single polymers and copolymers thereof, and the like.

Of these, bisphenol A,
2,2-bis{(4-hydroxy-3-methyl)phenyl}propane,
2,2-bis(4-hydroxyphenyl)butane,
2,2-bis(4-hydroxyphenyl)-3-methylbutane,
2,2-bis(4-hydroxyphenyl)-3,3-dimetylbutane,
2,2-bis(4-hydroxyphenyl)-4-methylpentane,
1,1-bis(4-hydroxyphenyl)-3,3,5-trimetylcyclohexane,
α,α′-bis(4-hydroxyphenyl)-m-diisopropylbenzene, and
   homopolymers and copolymers thereof, and the like are preferred. In particular, a homopolymer of bisphenol A or a copolymer made by copolymerizing
1,1-bis(4-hydroxyphenyl)-3,3,5-trimetylcyclohexane with one or more bivalent phenols selected from bisphenol A,
2,2-bis{(4-hydroxy-3-methyl)phenyl}propane and
α,α′-bis(4-hydroxyphenyl)-m-diisopropylbenzene is preferably used.

As the carbonate precursors, carbonyl halides, carbonate esters, haloformates or the like are used and examples thereof include specifically dihaloformates of phosgene, diphenyl carbonate or bivalent phenols, or the like.

A resin containing an alicyclic structure-containing ethylenic unsaturated monomer unit is a resin having an alicyclic structure in a repeat unit of a polymer. The examples include norbornene-based polymers, vinyl alicyclic hydrocarbon-based polymers, and the like.

The alicyclic structure may be contained in the main chain or in a side chain, or in both the main chain and a side chain. In view of obtaining an extruded resin sheet (A) excellent in light transmission properties, a resin in which the main chain has an alicyclic structure is preferable.

Specific examples of polymer resins containing such an alicyclic structure include norbornene-based polymers, cyclic olefin-based polymers with a single ring, cyclic conjugated diene-based polymers, vinyl alicyclic hydrocarbon-based polymers and hydrogenated polymers thereof, and the like. Among these, in terms of light transmission properties, hydrogenated norbornene-based polymers, vinyl alicyclic hydrocarbon-based polymers and hydrogenated polymers thereof, and the like are preferable and hydrogenated norbornene-based polymers are more preferable.

The transparent resin (P) may include a light diffusing agent as an additive. Inclusion of a light diffusing agent renders it possible to give an extruded resin sheet (A) that transmits incident light while diffusing the light. The light diffusing agent may be an inorganic particle or an organic particle.

Examples of the inorganic particle that can be used as a light diffusing agent include, for example, particles of calcium carbonate, barium sulfate, titanium oxide, aluminum hydroxide, silica, inorganic glass, mica, white carbon, magnesium oxide, zinc oxide, and the like. Such an inorganic particle may have its surface subjected to surface treatment with a fatty acid or the like.

Examples of the organic particle that can be used as a light diffusing agent include, for example, particles of a crosslinked resin such as styrene-based polymers with a crosslinked structure, acrylic resins with a crosslinked structure and siloxane-based resins with a crosslinked structure, a particle of resin with a high molecular weight such as styrene-based polymers with a high molecular weight and acrylic resins with a high molecular weight, and the like. Here, a crosslinked resin is a resin that has a gel fraction of 10% or more when dissolved in acetone. A resin with a high molecular weight is a resin having a weight average molecular weight (Mw) of 500,000 or more and normally 5,000,000 or less.

A styrene-based polymer is a resin having a styrene-based monomer unit as a main component such as, for example, a resin containing 50 mass % or more of a styrene-based monomer unit, which may be obtained by polymerization of a styrene-based monomer only and comprise 100 mass % of a styrene-based monomer unit, or may be a copolymer of a styrene-based monomer and a monomer capable of copolymerizing therewith.

The styrene-based monomer is styrene or a derivative thereof, and examples of the derivative of styrene include, for example, halogenated styrenes such as chlorostyrene and bromstyrene, vinyl toluene, alkyl-substituted styrenes such as α-methyl styrene, and the like. These are each used alone or in combination of two or more species.

A monomer capable of copolymerizing with the styrene-based monomer may be a single functional monomer having one double bond, or a polyfunctional monomer having two or more double bonds in the molecule, the double bond being capable of radical polymerization.

Examples of a single functional monomer capable of copolymerizing with the styrene-based monomer include, for example, methacrylic acid esters such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate, acrylic acid esters such as methyl acrylate, ethyl acrylate, butyl acrylate, cyclohexyl acrylate, phenyl acrylate, benzyl acrylate, 2-ethylhexyl acrylate and 2-hydroxyethyl acrylate, acrylonitrile, and the like. These are each used alone, or in combination of two or more species. Among such monomers, methacrylic acid alkyl esters such as methyl methacrylate are preferable.

Examples of the polyfunctional monomers include (normally do not include conjugate dienes for use), for example, alkyldiol dimethacrylates such as 1,4-butanediol dimethacrylate and neopentyl glycol dimethacrylate, alkyldiol diacrylates such as 1,4-butanediol diacrylate and neopentyl glycol diacrylate, alkylene glycol dimethacrylates such as ethylene glycol dimethacrylate, diethylene glycol dimethacrylate, tetraethylene glycol dimethacrylate, propylene glycol dimethacrylate and tetrapropylene glycol dimethacrylate, alkylene glycol diacrylates such as ethylene glycol diacrylate, diethylene glycol diacrylate, tetraethylene glycol diacrylate, propylene glycol diacrylate and tetrapropylene glycol diacrylate, methacrylates of polyalcohols such as trimethylol propane trimethacrylate and pentaerythritol tetramethacrylate, acrylates of polyalcohols such as trimethylol propane triacrylate and pentaerythritol tetraacrylate, aromatic polyfunctional compounds such as divinyl benzene and diallyl phthalate, and the like. These polyfunctional monomers are each used alone or in combination of two or more species.

A styrene-based polymer with a crosslinked structure can be obtained by copolymerizing the styrene-based monomer with the polyfunctional monomer. The examples include a copolymer of the styrene-based monomer and the polyfunctional monomer, a copolymer of the styrene-based monomer, the polyfunctional monomer and the single functional monomer, and the like.

The refractive index of the styrene-based polymer is normally from about 1.53 to about 1.61; the larger the content of monomer having a phenyl group, the higher the refractive index tends to be.

Particles of the styrene-based polymer can be manufactured by a usual method such as a suspension polymerization method, a micro suspension polymerization method, an emulsion polymerization method, or a dispersion polymerization method.

An acrylic resin is a resin having an acrylic monomer unit as a main component such as, for example, a resin containing 50 mass % or more of an acrylic monomer unit, which may be obtained by polymerization of an acrylic monomer only and comprise 100 mass % of an acrylic monomer unit, or may be a copolymer of an acrylic monomer and a monomer capable of copolymerizing therewith.

Examples of the acrylic monomer include, for example, methacrylic acid esters such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate, acrylic acid esters such as methyl acrylate, ethyl acrylate, butyl acrylate, cyclohexyl acrylate, phenyl acrylate, benzyl acrylate, 2-ethylhexyl acrylate and 2-hydroxyethyl acrylate, methacrylic acid, acrylic acid, and the like. These are each used alone, or in combination of two or more species.

A monomer capable of copolymerizing with an acrylic monomer may be a single functional monomer having one double bond, or a polyfunctional monomer having two or more double bonds in the molecule, the double bond being capable of radical polymerization.

Examples of the single functional monomer capable of copolymerizing with an acrylic monomer include, for example, styrene and a derivative thereof. Examples of the derivative of styrene include, for example, halogenated styrenes such as chlorostyrene and bromstyrene, vinyl toluene, alkyl-substituted styrenes such as α-methyl styrene, and the like. These are each used alone or in combination of two or more species. Among these, styrene is preferably used.

Examples of the polyfunctional monomer capable of copolymerizing with an acrylic monomer include (normally do not include conjugate dienes for use), for example, alkyldiol dimethacrylates, alkyldiol diacrylates, alkylene glycol dimethacrylates, alkylene glycol diacrylates, methacrylates of polyalcohols, acrylates of polyalcohols, aromatic polyfunctional compounds, and the like as noted above as the polyfunctional monomer capable of copolymerizing with the styrene-based monomer. These are each used alone, or in combination of two or more species.

An acrylic resin with a crosslinked structure can be obtained by copolymerizing the acrylic monomer with the polyfunctional monomer. The examples include a copolymer of the acrylic monomer and the polyfunctional monomer, a copolymer of the acrylic monomer, the polyfunctional monomer and the single functional monomer, and the like,

The refractive index of the acrylic resin varies depending on monomer units constituting the resin; however, it is normally from about 1.46 to about 1.55; the larger the content of monomer unit having a halogen atom, the higher the refractive index tends to be.

Particles of the acrylic resin can be manufactured by a usual method such as a suspension polymerization method, a micro suspension polymerization method, an emulsion polymerization method, or a dispersion polymerization method.

A siloxane-based resin is generally called silicone rubber or silicone resin, and is solid at room temperature. A siloxane-based resin is produced by, for example, hydrolysis and condensation of chlorosilane. For instance, condensation and hydrolysis of a chlorosilane such as dimethyldichlorosilane, diphenyldichlorosilane, phenylmethyldichlorosilane, methyltrichlorosilane, or phenyltrichlorosilane can provide a siloxane-based resin with a crosslinked structure or non-crosslinked structure. When a siloxane-based resin with a non-crosslinked structure has been obtained, a method of reacting this resin with a peroxide such as benzoyl peroxide, 2,4-dichlorbenzoyl peroxide, p-chlorbenzoyl peroxide, dikymyl peroxide, di-t-butyl peroxide, or 2,5-dimethyl-2,5-di(t-butyl peroxy)hexane to crosslink, or introducing a silanol group into the terminal of the high molecular chain and then condensation crosslinking it with an alkoxysilane can produce a siloxane-based resin with a crosslinked structure. Among these, a resin having 2 to 3 organic groups per silicon atom is preferred.

A crosslinked siloxane-based resin is normally obtained in a lump form, and thus this is mechanically crushed to particles for use.

The refractive index of the siloxane resin with a crosslinked structure varies depending on the kind, content, or the like of monomer units constituting the resin. However, the more monomer units having a phenyl group or the larger the content of an organic residue bonded to a silicon atom, the larger the refractive index tends to be.

The particle diameter of the light diffusing agent is normally from 0.5 μm to 50 μm, preferably from 1 μm to 30 μm.

Use of a light diffusing agent of which the refractive index differs from the refractive index of the transparent resin (P) by 0.02 or more and normally 0.13 or less and dispersion of the light diffusing agent within the extruded resin sheet (A) can have transmitted light diffused inside the sheet (internal diffusion). Moreover, use of a light diffusing agent of which the refractive index differs from the refractive index of the transparent resin (P) by less than 0.02 and dispersion of the light diffusing agent on the surface of the extruded resin sheet (A) can have transmitted light diffused on the surface of the sheet (external diffusion).

The light diffusing agent may be uniformly dispersed into the entire extruded resin sheet (A). When the extruded resin sheet (A) is used as, for example, a transparent base sheet (A1) constituting a Fresnel lens sheet (11), the transparent base sheet may have a two-layer construction, each layer having a different thickness, in which a larger amount of the light diffusing agent is dispersed into a thinner layer, When the extruded resin sheet (A) is used as a transparent base sheet (A2) constituting a lenticular lens sheet (12), the transparent base sheet may have a three-layer construction, a five-layer construction or the like, in which the light diffusing agent is dispersed only into the inner layers, and is not dispersed into the layers constituting both surfaces.

The transparent resin (P) may include a UV absorber as an additive. It is normally used a UV absorber capable of absorbing an ultraviolet ray in the wavelength range of from 250 nm to 380 nm, and preferably a UV absorber having a local maximum absorption wavelength in this range, and more preferably a UV absorber having the largest absorption wavelength (λmax) in the range of 250 nm to 320 nm, which is largest in the ultraviolet-visible region of from 250 nm to 800 nm.

Examples of the UV absorber include, for example, malonate-based UV absorber, acetate-based UV absorber. oxalanilide-based UV absorber, benzophenone-based UV absorber, benzotriazol-based UV absorber, cyanoacrylate-based UV absorber, salicylate-based UV absorber, nickel complex-based UV absorber, benzoate-based UV absorber, and the like.

The content of UV absorber is normally from 0.01 mass part to 3 mass parts based on 100 mass parts of the transparent resin (P). The UV absorber whose molar absorbance coefficient (εmax) in the range of from 250 nm to 320 nm is 1000 mol⁻¹ cm⁻¹ or more, or further 5000 mol⁻¹ cm⁻¹ and whose molecular weight (Mw) is 400 or less is preferable because of being capable of reducing the content.

The transparent resin (P) may include a hindered amine together with the UV absorber. The inclusion of the hindered amine can make the extruded resin sheet (A) more excellent in light resistance.

The transparent resin (P) may include a surfactant as an additive. Inclusion of the surfactant enables prevention of adhesion of dust. Examples of the surfactant include anionic surfactants such as sodium lauryl sulfate, sodium cetyl sulfate and sodium stearyl sulfate, cationic surfactants, ampholytic surfactants, nonionic surfactants, and the like, with the anionic surfactants mentioned above being preferable. When the surfactant is included therein, the content is normally from 0.1 mass part to 5 mass parts, preferably from 0.2 mass parts to 3 mass parts, more preferably from 0.3 mass part to 1 mass part, based on 100 mass parts of the transparent resin (P).

The transparent resin (P) may include as additives an impact modifier, an antistatic agent, an antioxidant, a lubricant, a fire retardant, and a coloring agent such as a dye or pigment. Examples of the impact modifier include, for example, an acrylic multilayer-structure rubber particle, a graft rubber-like polymer particle, and the like. Examples of the antistatic agent include, for example, high molecular antistatic agents such as a polyether ester amide. Examples of the antioxidant include, for example, hindered phenol, and the like. Examples of the lubricant include, for example, palmitic acid, stearyl alcohol, and the like.

These additives can be included in the transparent resin (P), for example, by kneading the additives with the transparent resin (P) in a heat melt state.

The extruded resin sheet (A) used in the transmissive screen of the present invention is an extruded resin sheet (A) obtained by extruding the transparent resin (P) in a heat melt state from a die (D) in one direction, and specifically it can be obtained by a process for producing the extruded resin sheet (A); the process comprises extruding the transparent resin (P) from a die (1) in a heat melt state, nipping the resin in between a first cooling roll (R1) and a second cooling roll (R2), winding the resin on the second cooling roll (R2), and then winding the resin on one lattercooling roll (R3), or winding the resin on a plurality of lattercooling rolls (R3, R4 . . . ) one after another to cool the resin, and then further cooling the resin while maintaining the resin in a flat state to solidify, and subsequently withdrawing the resin by means of a pair of take-off rolls (N1, N2), wherein the peripheral speed (V₃) of the one lattercooling roll (R3) or the average peripheral speed (V₃ₐ) of the plurality of the lattercooling rolls (R3, R4 . . . ) is made to be 0.94 times to 1.03 times the average peripheral speed (V₁₂) of the first cooling roll (R1) and the second cooling roll (R2), the average peripheral speed (Vₙ) of the pair of the take-off rolls (N1, N2) is made to be 0.95 times to 1.03 times the peripheral speed (V₃) of the one lattercooling roll (R3) or the average peripheral speed (V₃ₐ) of the plurality of the lattercooling rolls (R3, R4 . . . ), and the average peripheral speed (Vₙ) of the pair of the take-off rolls (N1, N2) is made to be 0.95 times to 0.995 times the average peripheral speed (V₁₂) of the first cooling roll (R1) and the second cooling roll (R2).

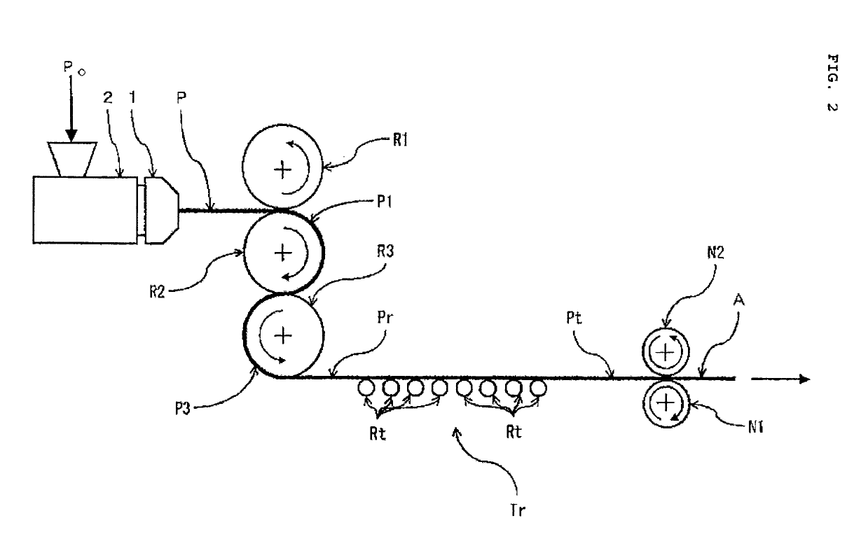

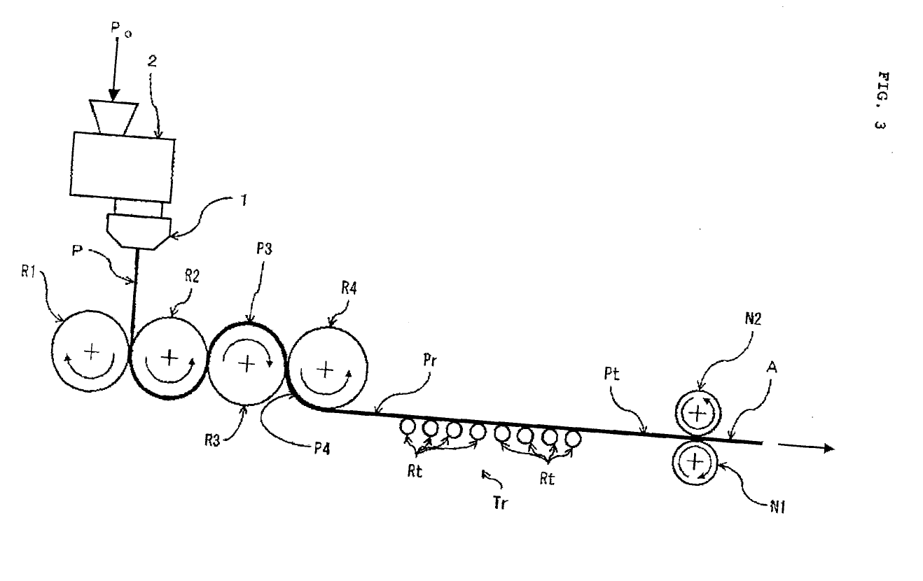

To make the transparent resin (P) be in a heat melt state may involve, as in the usual method of extrusion molding, for example, as shown in FIGS. 2 and 3, the transparent resin (P) may be heated by means of an extruder (2) and pumped to the die (1) while melt kneading. The transparent resin (P) pumped from the extruder (2) is extruded as a sheet shape in a heat melt state from the die (1).

As the die (1), a T die is normally used. The die (1) may be a single layer die extruding one transparent resin in a single layer, or a multilayer die, such as a feed block die, a multi-manifold die, and the like, laminating and co-extruding two or more transparent resins (P) each independently pumped from extruders (2).

The transparent resin (P) extruded from the die (1) is inserted in between the first cooling roll (R1) and the second cooling roll (R2).

As the first cooling roll (R1) and the second cooling roll (R2), rolls having substantially the same diameter with respect to each other are usually used, and the diameter is normally from 25 cm to 100 cm. The first cooling roll (R1) and the second cooling roll (R2) are normally made of a metallic material such as stainless steel; mirror surface-like, plating finished rolls are used, Temperatures of the first cooling roll (R1) and the second cooling roll (R2) each are adjusted in such a way that the transparent resin (P) extruded from the die (1) is cooled to a predetermined temperature.

The first cooling roll (R1) and the second cooling roll (R2) are rotation-driven via an electric motor (not shown) or the like at substantially the same peripheral speed with respect to each other, for example, in such a way that the peripheral speed of the second cooling roll (R2) is from 0.98 times to 1.02 times the peripheral speed of the first cooling roll (R1).

A transparent resin (P1) after being inserted in between the first cooling roll (R1) and the second cooling roll (R2) is normally wound on the second cooling roll (R2) while kept in contact with the second cooling roll (R2).

A transparent resin (P2) after being wound on the second cooling roll (R2) is wound on one aftercooling roll (R3), or wound on a plurality of lattercooling rolls (R3, R4 . . . ) one after another.

The lattercooling rolls (R3, R4 . . . ), the diameters of which are substantially the sane as the diameters of the first cooling roll (R1) and the second cooling roll (R2), are normally used; the lattercooling rolls, the surface of which are made of a metallic material such as stainless steel and mirror finished, are normally used. The temperatures of the lattercooling rolls (R3, R4 . . . ) are adjusted such that the transparent resin (P) extruded from the die (1) is cooled to a predetermined temperature.

FIG. 2 shows an example of using one lattercooling roll alone. In this example, the transparent resin (P2) wound on the second cooling roll (R2) is normally inserted in between the second cooling roll (R2) and the lattercooling roll (R3), and then is wound on the lattercooling roll (R3) while kept in contact therewith. The single lattercooling roll (R3) is rotation-driven via, for example, an electric motor (not shown) or the like.

FIG. 3 shows an example of using a plurality of lattercooling rolls. In this example, when a plurality of lattercooling rolls (R3, R4 . . . ) are used, the number of rolls is normally from 2 to 4; FIG. 2 shows an example of using two lattercooling rolls (R3, R4).

The transparent resin (P2) wound on the second cooling roll (R2) is normally inserted in between the second cooling roll (R2) and the first roll (R3) of the plurality of lattercooling rolls, and then is wound on the first roll (R3) and successively inserted in between the next lattercooling rolls (R4 . . . ) and wound thereon.

The plurality of the lattercooling rolls (R3, R4 . . . ) each are rotation-driven by means of, for example, electric motors (not shown) or the like.

In this manner, by being wound on the single lattercooling roll (R3) (FIG. 2) or wound on the plurality of lattercooling rolls (R3, R4 . . . ) one after another (FIG. 3), a transparent resin (Pr) after being cooled is not still sufficiently solidified and is in a soft state capable of heat deformation; the temperature is preferably higher than or equal to a heat deformation temperature of the transparent resin (P).

Next, as shown in FIGS. 2 and 3, the transparent resin (Pr) is further cooled and solidified while kept in a flat state. In order to further cool and solidify the transparent resin (Pr) while keeping in a flat state, the resin may, for example, be delivered on a roller table (Tr) comprised of a plurality of delivering rollers (Rt) in the air and cooled, as in the usual method of extrusion molding. The cooling of the transparent resin (Pr) while kept in a flat state is preferably carried out in an atmosphere of at 35° C. or higher. In terms of the possibility of shortening the delivery distance until solidification of the transparent resin (Pr), the cooling is normally carried out at 65° C. or lower, preferably at 60° C. or lower, further preferably at 50° C. or lower, particularly preferably at 45° C. or lower.

As shown in FIGS. 2 and 3, a transparent resin (Pt) subsequent to solidification is withdrawn by means of a pair of take-off rolls (N1, N2). As the pair of the take-off rolls (N1, N2), rolls having substantially the same diameter with respect to each other are usually used, and the diameter is normally from about 15 cm to about 80 cm. The pair of the take-off rolls (N1, N2) each, the surface of which are normally made of a metallic material such as stainless steel and mirror finished, the surface of which are made of rubber, or the like, is used. The pair of the take-off rolls (N1, N2) are rotation-driven via, for example, an electric motor (not shown) or the like at substantially the same peripheral speed with respect to each other, for example, in such a way that the peripheral speed of one take-off roll (N1) is from 0.98 times to 1.02 times the peripheral speed of the other take-off roll (N2). The transparent resin (Pt) after solidification is inserted into the take-off rolls (N1, N2) and withdrawn.

The extruded resin (A) after withdrawal via the take-off rolls (N1, N2) is normally cut into an appropriate length.

A resin sheet used in the transmissive screen of the present invention is the extruded resin sheet (A) thus obtained; in the case where the resin sheet is subjected to a heating test of maintaining the resin sheet at 150° C. for 1 hour, the shrinkage factor (S) in the extrusion direction evaluated from Equation (1) above satisfies Equation (2) above. When the shrinkage factor (S) is less than 2/X, the sheet is apt to distort when heated. When the shrinkage factor (S) exceeds 18/X, the sheet is prone to greatly shrink on ultraviolet radiation or heat, and, it is easily color-drifted in case an LCD projector is used as a projector (4).

The heating test is carried out by cutting the extruded resin sheet (A) to, for example, a size of 10 cm by 10 cm, precisely measuring the length (L₀) in the extrusion direction, flatly putting the resulting sheet on a flat plate over which a lubricant inorganic powder such as talc is densely spread, putting the sheet in a thermostat at 150° C. and maintaining it for one hour, cooling it and then measuring the length (L₁) in the extrusion direction.

For producing the extruded resin sheet (A) such that the shrinkage factor (S) satisfies Equation (2), for example, the cooling speed of the transparent resin (P) after being extruded from the die (1) may be made low. Specifically, the extruding speed of the transparent resin (P) from the die (1) maybe made low and also the temperatures of the first cooling roll (R1), the second cooling roll (R2) and the lattercooling rolls (R3, . . . ) may be made slightly lower than the temperature of the transparent resin when it is inserted in between them or is wound thereon, or the atmosphere may be kept warm by being covered with a booth or the like.

Additionally, as shown in FIG. 2, when a single lattercooling roll is used, the peripheral speed (V₃) of the lattercooling roll (R3) may be made to be 0.94 times to 1.03 times, preferably 0.96 times to 1.0 times, more preferably 0.995 times or less the average peripheral speed (V₁₂) of the first cooling roll (R1) and the second cooling roll (R2); the average peripheral speed (Vₙ) of the pair of the take-off rolls (N1, N2) for withdrawing the transparent resin (Pt) after solidification may be made to be 0.95 times to 1.03 times, preferably 0.96 times to 1.01 times, more preferably 0.97 times to 0.995 times the peripheral speed (V₃) of the lattercooling roll (R3); and also the average peripheral speed (Vₙ) of the pair of the take-off rolls (N1, N2) may be made to be 0.95 times to 1.015 times, preferably from 0.95 times to 0.995 times the average peripheral speed (V₁₂) of the first cooling roll (R1) and the second cooling roll (R2).

Thus, an extruded resin sheet (A) with little distortion when the sheet is exposed to ultraviolet radiation or heating can be obtained.

Also, as shown in FIG. 3, when a plurality of lattercooling rolls (R3, R4 . . . ) are used, the average peripheral speed (V₃ₐ) of the lattercooling rolls (R3, R4 . . . ) may be made to be 0.94 times to 1.03 times, preferably 0.96 times to 1.0 times, more preferably 0.995 times or less the average peripheral speed (V₁₂) of the first cooling roll (R1) and the second cooling roll (R2); the average peripheral speed (Vₙ) of the pair of the take-off rolls (N1, N2) may also be made to be 0.95 times to 1.03 times, preferably 0.96 times to 1.01 times, more preferably 0.97 times to 0.995 times the average peripheral speed (V₃ₐ) of the plurality of the lattercooling rolls (R3, R4 . . . ); and also the average peripheral speed (Vₙ) of the pair of the take-off rolls (N1, N2) may be made to be 0.95 times to 1.015 times, preferably 0.95 times to 0.995 times the average peripheral speed (V₁₂) of the first cooling roll (R1) and the second cooling roll (R2).

Thus, an extruded resin sheet (A) with little distortion when the sheet is exposed to ultraviolet radiation or heating can be obtained.

The sheet thickness (X) of the extruded resin sheet (A) used in the transmissive screen of the present invention is normally 0.8 mm or more in terms of hardly bent properties, normally 5 mm or less in terms of weight when the sheet is used for a large area screen. The thickness of the extruded resin sheet (A) can be adjusted depending on, for example, the thickness of the transparent resin (P) extruded from the die (1), the interval between the first cooling roll (R1) and the second cooling roll (R2), or the like.

The transmissive screen of the present invention has the above extruded resin sheet (A) as a member and, as other members, normally a Fresnel lens layer, a lenticular lens film and a hard coat layer.

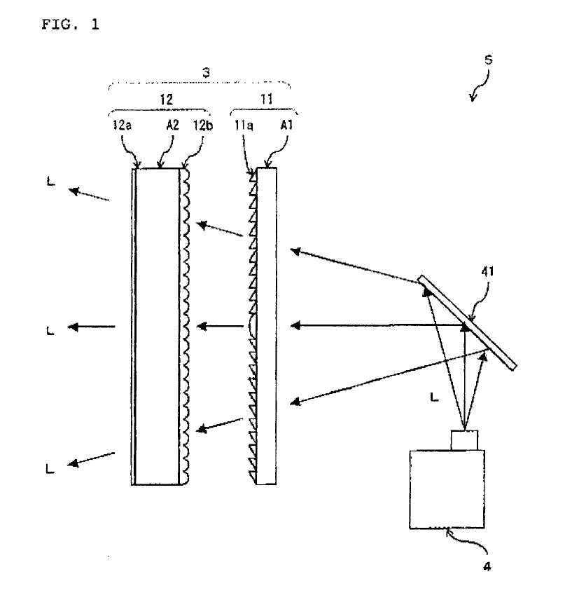

The above extruded resin sheet (A) can be used, for example as shown in FIG. 1, as the transparent base sheet (A1) constituting the Fresnel lens sheet (11). The Fresnel lens sheet (11) is, for example, a sheet disposed on a back side in a two-sheet type transmissive screen (3) indicated in FIG. 1, and a sheet having a Fresnel lens layer (11a) formed on one face to be the front side surface of the transparent base sheet (A1). The Fresnel lens layer (11a) is a layer made by curing a curing resin and has a Fresnel lens shape of a target. The other face to be the back side of the transparent base sheet (A1) is normally a smooth, unprocessed face.

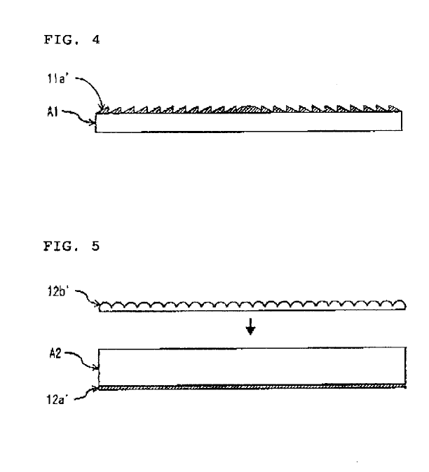

The Fresnel lens sheet (11) can be manufactured by, for example as illustrated in FIG. 4, forming a curing resin layer (11a′) on one face to be the front side of the extruded resin sheet (A) in the transmissive screen of the present invention, and subsequently curing the layer (11a′) to form the Fresnel lens layer (11a). As a curing resin constituting the curing resin layer (11a′), a UV curable resin cured by being irradiated with an ultraviolet ray, or a thermosetting resin cured by heating, is used. The curing resin layer (11a′) is formed such that its surface is like a Fresnel lens. By means of ultraviolet radiation when a UV curable resin is used as the curing resin, or by means of heating when a thermosetting resin is used, the curing resin layer (11a′) is respectively cured, thereby being capable of forming the Fresnel lens layer (11a) of a target.

The above extruded resin sheet (A) can also be used, as shown in FIG. 1, as the transparent base sheet (A2) constituting the lenticular lens sheet (12). The lenticular lens sheet (12) is, for example, a sheet disposed on the front side in the two-sheet type transmissive screen (3) indicated in FIG. 1, and a sheet having a hard coat layer (12a) formed on one face to be the front side surface of the transparent base sheet (A2) and the lenticular lens film (12b) laminated on the other face to be the back side surface thereof. The hard coat layer (12a) is formed for scratch prevention.

The lenticular lens sheet (12) can be manufactured by, for example as illustrated in FIG. 5, applying a hard coating agent on one face of the extruded resin sheet (A) to form a hard coating agent layer (12a′), and then curing the layer (12a′) to form the hard coat layer (12a), and laminating the lenticular lens film (12b) on the other face thereof. As the hard coating agent, a UV curable hard coating agent cured by ultraviolet radiation, or a thermosetting hard coating agent cured by heating, is used. By means of ultraviolet radiation when a UV curable hard coating agent is used as the hard coating agent, or by means of heating when a thermosetting hard coating agent is used, the hard coating agent layer (12a′) is respectively cured, thereby being capable of forming the hard coat layer (12a).

The Fresnel lens sheet (11) and lenticular lens sheet (12), using the above extruded resin sheet (A) as the transparent base sheets (A1, A2), can be used, for example as shown in FIG. 1, in the two-sheet type transmissive screen (3). The Fresnel lens sheet (11) and lenticular lens sheet (12) of the transmissive screen (3) are disposed in such a way that the Fresnel lens layer (11a) of the Fresnel lens sheet (11) and the lenticular lens layer (12b) of the lenticular lens sheet (12) face each other.

The two-sheet type transmissive screen (3) is, for example as shown in FIG. 1, used in a rear projection type display apparatus (5). The display apparatus (5) includes the above transmissive screen (3) and a projector (4). The projector has the function to project an image from the back side of the transmissive screen (3). The transmissive screen (3) has the Fresnel lens sheet (11) disposed on the back side and has the lenticular lens sheet (12) disposed on the front side.

The two-sheet type transmissive screen (3) comprising the Fresnel lens sheet (11) and lenticular lens sheet (12), both using the above extruded resin sheet (A) as the transparent base sheets (A1, A2), can also be used in the rear projection type display apparatus (5) using as the projector (4) a projector of a cold cathode-ray tube type. However, the transmissive screen is suitably used, from the viewpoint of proving a non-color-drifted image, in the case where as the projector (4) is used an LCD projector of forming an image by means of a liquid crystal cell (not shown) and polarizing plates (not shown) disposed on both sides thereof to project the image. In such rear projection type display apparatus (5), normally for example as shown in FIG. 1, the projector (4) is placed in a lower part of the apparatus and light (L) from the projector (4) is changed in its direction with a mirror (4l) and projected onto the transmissive screen (3) in order to make the size of the depth direction of the entire apparatus small.

The process for producing the extruded resin sheet (A) of the present invention can also use a thermoplastic resin other than the transparent resin (P) and can obtain an extruded resin that is hardly warped even when a single side of the sheet is exposed to an ultraviolet ray or a heat ray.

### EXAMPLES

The present invention will be set forth in more detail in terms of Examples hereinafter, however, the invention is by no means limited by such Examples.

The evaluation methods in each Example are as follows:

(1) Shrinkage Factor S (%)

An extruded resin sheet (A) was cut to a size of 10 cm by 10 cm; a resulting sheet was flatly put on a metal tray over which talc was densely spread; the bat with the sheet was put in a thermostat set at 150° C.; the length (L₁) in the extrusion direction was measured after one hour; from the length (L₁) and the length (L₀) in the extrusion direction before introduction into the thermostat, the shrinkage factor S was evaluated in accordance with Equation (1).

(2) Color-drifting

On one face of one sheet of the obtained extruded resin sheets (A) was formed a Fresnel lens layer (11a) to form a Fresnel lens sheet (11); on one face of another sheet of the extruded resin sheet (A) was formed a hard coat layer (12a) and on the other face was laminated a lenticular lens film (12b) to form a lenticular lens sheet (12); the Fresnel lens layer (11a) of the Fresnel lens sheet (11) and the lenticular lens film (12b) of the lenticular lens sheet (12) were disposed face-to-face to each other and the resulting material was used as a transmissive screen of a projection television (5) loading an LCD projector (4); in the white image plane and black image planes the extents of coloring of respective image plane ends were visually evaluated.

(3) Atmosphere Temperature

The temperature was measured by means of a thermo recorder (“RT-21S” available from Espec Mic Corp.)

(4) Resin Temperature

The temperature was measured using a laser type non-contact thermometer (available from Keyence Corporation) on a thermoplastic resin (Pr) just after separation from the last lattercooling roll (R4).

(5) Distortion

The extruded resin sheet (A) thus obtained was cut to 50 by 50 cm squares; to one face of the sheet was thinly and uniformly applied a UV curable resin paint solution (“Hitaroid 7851” available from Hitachi Chemical Co., Ltd.) and only from the side of the applied face ultraviolet ray was radiated thereto and then the distortion extent of the extruded resin sheet (A) after being cured was visually evaluated. Non-distorted sheet was marked by o; a slightly distorted sheet was marked by Δ; a largely shrunk sheet or a sheet an end of which was hung and distorted was marked by x.

### Examples 1 to 7

To 98 mass parts of a copolymer (refractive index 1.53, heat distorted temperature 100° C.) of 60 mass parts of methyl methacrylate and 40 mass parts of styrene was added 2 mass parts of copolymer particles (average particle diameter 10 μm, refractive index 1.49) of 95 mass parts of methyl methacrylate and 5 mass parts of ethylene glycol dimethacrylate, and the resulting material was sufficiently mixed by means of a Henschel mixer, and then a thermoplastic resin (P) obtained by melt kneading while heating by means of an extruder (2) (screw diameter 130 mm, uniaxial type) was extruded in a melt state from a T die (1).

As shown in FIG. 3, the thermoplastic resin (P) extruded from the T die (1) was inserted in between a first cooling roll (R1) and a second cooling roll (R2), and wound on the second cooling roll (R2) while kept in contact with the roll and inserted in between the second cooling roll (R2) and a third cooling roll (R3), and then wound on the third cooling roll (R3) while kept in contact with the roll and inserted in between the third cooling roll (R3) and a forth cooling roll (R4), and wound on the forth cooling roll (R4). The first cooling roll (R1), the second cooling roll (R2), the third cooling roll (R3), and the forth cooling roll (R4), which were used, are made of stainless steel and have a diameter of 50 cm and have a surface plating-finished like a mirror face.

The resin temperature of a thermoplastic resin (Pr) after being wound on the forth cooling roll (R4) was 103° C. Thereafter, the methacrylic resin (Pr) was delivered and cooled, while being maintained in a flat state on a roller table (Tr) comprising 25 delivering rolls (Rt), for solidification, and then withdrawn by means of a pair of take-off rolls (N1, N2) to obtain an extruded resin sheet (A) of 1.85 mm thick and 150 cm wide. The take-off rolls (N1, N2) used have a diameter of 30 cm and are made of rubber.

Here, a passage passing from the T die (1) through the first cooling roll (R1), second cooling roll (R2), the lattercooling rolls (R3, R4) and the roller table (Rt) until the take-off rolls (N1, N2) was covered with a booth in advance and the temperature within the booth was made to be the atmosphere temperature. The peripheral speed of each of the rolls and the thicknesses of the extruded resin sheets are shown in Table 1.

The results are listed in Table 1.

TABLE 1

| | Example | Example | Example | Example | Example | Example | Example |
|---|---|---|---|---|---|---|---|
| | 1 | 2 | 3 | 4 | 5 | 6 | 7 |
| peripheral speed | | | | | | | |
| (m/sec) | | | | | | | |
| first cooling roll | 2.84 | 2.84 | 2.84 | 2.84 | 2.84 | 3.45 | 2.14 |
| second cooling roll | 2.84 | 2.84 | 2.84 | 2.84 | 2.84 | 3.44 | 2.15 |
| average | 2.84 | 2.84 | 2.84 | 2.84 | 2.84 | 3.45 | 2.15 |
| peripheral speed | | | | | | | |
| (V₁₂) | | | | | | | |
| third cooling roll | 2.83 | 2.83 | 2.83 | 2.83 | 2.83 | 3.41 | 2.11 |
| forth cooling roll | 2.88 | 2.88 | 2.82 | 2.82 | 2.82 | 3.32 | 2.07 |
| fifth cooling roll | 2.88 | 2.89 | 2.51 | 2.51 | 2.81 | 3.33 | 2.08 |
| average | 2.87 | 2.87 | 2.82 | 2.82 | 2.82 | 3.35 | 2.09 |
| peripheral speed | | | | | | | |
| (V) | | | | | | | |
| take-off roll (Vₙ) | 2.87 | 2.84 | 2.79 | 2.77 | 2.82 | 3.33 | 2.07 |
| V/V₁₂ | 1.010 | 0.933 | 0.993 | 0.993 | 0.994 | 0.973 | 0.973 |
| Vₙ/V | 1.001 | 1.007 | 0.989 | 0.992 | 0.999 | 0.993 | 0.992 |
| V/V₁₂ | 1.011 | 1.000 | 0.982 | 0.975 | 0.993 | 0.966 | 0.965 |
| resin | 104 | 104 | 103 | 104 | 106 | 102 | 111 |
| temperature (° C.) | | | | | | | |
| atmosphere | 37 | 37 | 38 | 38 | 40 | 42 | 42 |
| temperature (° C.) | | | | | | | |
| extruded resin sheet | | | | | | | |
| thickness (mm) | 1.85 | 1.85 | 1.85 | 1.85 | 1.85 | 1.55 | 3.00 |
| shrinkage factor | 9 | 8 | 6 | 5 | 4 | 6 | 3 |
| (%) | | | | | | | |
| distortion | ∘ | ∘ | ∘ | ∘ | ∘ | ∘ | ∘ |
| properties | | | | | | | |
| color-drifting | No | No | No | No | No | No | No |

### Comparative Examples 1 to 3

Operations were carried out as in Example 1 with the exception that the peripheral speed of each of the rolls and the thicknesses of the extruded resin sheets were as shown in Table 2. The results are listed in Table 2.

TABLE 2

| | Comparative | Comparative | Comparative |
|---|---|---|---|
| | example 1 | example 2 | example 3 |
| peripheral speed | | | |
| (m/sec) | | | |
| first cooling roll | 2.84 | 2.84 | 3.47 |
| second cooling roll | 2.84 | 2.84 | 3.47 |
| average peripheral | 2.84 | 2.84 | 3.47 |
| speed (V₁₂) | | | |
| third cooling roll | 2.83 | 2.83 | 3.35 |
| forth cooling roll | 2.88 | 2.88 | 3.34 |
| fifth cooling roll | 2.89 | 2.89 | 3.33 |
| average peripheral | 2.87 | 2.87 | 3.34 |
| speed (V) | | | |
| take-off roll (Vₙ) | 2.93 | 2.89 | 3.27 |
| V/V₁₂ | 1.010 | 1.010 | 0.963 |
| Vₙ/V | 1.022 | 1.008 | 0.979 |
| V/V₁₂ | 1.032 | 1.018 | 0.942 |
| resin temperature (° C.) | 103 | 102 | 108 |
| atmosphere | 33 | 33 | 42 |
| temperature (° C.) | | | |
| extruded resin sheet | | | |
| thickness (mm) | 1.85 | 1.85 | 1.85 |
| shrinkage factor (%) | 11 | 10 | 2 |
| distortion properties | x | x | Δ |
| color-drifting | Yes | Yes | No |

### Examples 8 to 11

Operations were carried out as in Example 1 with the exception that the copolymer particles were not used, the copolymer (refractive index 1.53, heat distorted temperature 100° C.) of 60 mass parts of methyl mathacrylate and 40 mass parts of styrene was used alone, and the peripheral speed of each of the rolls, the resin temperatures, the atmosphere temperatures and the thicknesses of the extruded resin sheets were as shown in Table 3. The results are listed in Table 3.

TABLE 3

| | Example | Example | Example | Example |
|---|---|---|---|---|
| | 8 | 9 | 10 | 11 |
| peripheral speed | | | | |
| (m/sec) | | | | |
| first cooling roll | 3.05 | 2.88 | 2.33 | 1.92 |
| second cooling roll | 3.06 | 2.87 | 2.34 | 1.92 |
| average peripheral | 3.06 | 2.88 | 2.34 | 1.92 |
| speed (V₁₂) | | | | |
| third cooling roll | 3.03 | 2.85 | 2.32 | 1.89 |
| forth cooling roll | 2.94 | 2.80 | 2.24 | 1.84 |
| fifth cooling roll | 2.93 | 2.80 | 2.24 | 1.84 |
| average peripheral | 2.97 | 2.83 | 2.27 | 1.86 |
| speed (V) | | | | |
| take-off roll (Vₙ) | 2.97 | 2.82 | 2.24 | 1.86 |
| V/V₁₂ | 0.971 | 0.980 | 0.971 | 0.967 |
| Vₙ/V | 1.001 | 1.005 | 0.988 | 0.985 |
| V/V₁₂ | 0.972 | 0.985 | 0.959 | 0.932 |
| resin temperature (° C.) | 110 | 110 | 111 | 111 |
| atmosphere | 46 | 45 | 46 | 46 |
| temperature (° C.) | | | | |
| extruded resin sheet | | | | |
| thickness (mm) | 1.85 | 2.00 | 2.50 | 3.00 |
| shrinkage factor (%) | 5 | 3 | 3 | 4 |
| distortion properties | ∘ | ∘ | ∘ | ∘ |
| color-drifting | No | No | No | No |

1. A transmissive screen having as a member an extruded resin sheet (A) obtained by extrusion of a transparent resin (P) in a heat melt state from a die (D) in one direction, wherein
in the case where the extruded resin sheet (A) is subjected to a heating test of maintaining the resin sheet at 150° C. for 1 hour, the shrinkage factor (S) in the extrusion direction evaluated from Equation (1):
S=(L₀−L₁)/L₀×100 (1)
wherein S represents the shrinkage factor (%) in the extrusion direction, L₀ represents the length (mm) in the extrusion direction prior to the heating test, and L₁ represents the length (mm) in the extrusion direction after the heating test, satisfies Equation (2):
2/X≦S≦18/X (2)
wherein S means the same as S in Equation (1), and X represents the sheet thickness (mm) of the extruded resin sheet (A).

2. The transmissive screen of claim 1, wherein
the transparent resin (P) comprises a resin selected from methacrylic resins, styrene resins, aromatic polycarbonate resins and resins containing an alicyclic structure-containing ethylenic unsaturated monomer unit.

3. The transmissive screen of claim 1, wherein, the sheet thickness (X) is from 0.8 mm to 5 mm.

4. A Fresnel lens sheet having formed thereon a Fresnel lens layer (11a) made by curing a curing resin on one face of the excluded resin sheet (A) of claim 1.

5. A process for producing the Fresnel lens sheet of claim 4, the process comprising:
forming a curing resin layer (11a′), the surface of which is a Fresnel lens shape, on one face of the excluded resin sheet (A) of claim 1, and then
exposing the resulting layer to ultraviolet radiation or heat to cure the layer (11a′) to form the Fresnel lens layer (11a).

6. A lenticular lens sheet made by forming a hard coat layer (12a) on one face of the excluded resin sheet (A) of claim 1 and laminating a lenticular lens film (12b) on the other face thereof.

7. A process for producing the lenticular lens sheet of claim 6, the process comprising:
forming a hard coating agent layer (12a′) on a single face of the excluded resin sheet (A) of claim 1, and then
exposing the layer to ultraviolet radiation or heat to cure the layer (12a′) to form the hard coat layer (12a), and
laminating a lenticular lens film (12b) on the other face thereof.

8. A transmissive screen, comprising: the Fresnel lens sheet (11) of claim 4 and the lenticular lens sheet (12) of claim 6, wherein
the Fresnel lens layer (11a) of the Fresnel lens sheet (11) and the lenticular lens film (12b) of the lenticular lens sheet (12) are disposed face-to-face to each other.

9. A rear projection type display apparatus, comprising: the transmissive screen (3) of claim 1 or 8 and a projector (4) to project an image from the back of the transmissive screen (3), wherein
the transmissive screen (3) has the Fresnel lens sheet (11) disposed on the back side thereof and has the lenticular lens sheet (12) disposed on the front side thereof, and the projector (4) comprises an LCD projector.

10. A process for producing an extruded resin sheet (A), comprising:
extruding a thermoplastic resin from a die (1) in a heat melt state,
nipping the resin in between a first cooling roll (R1) and a second cooling roll (R2), winding the resin on the second cooling roll (R2), and then
winding the resin on one lattercooling roll (R3), or winding the resin on a plurality of lattercooling rolls (R3, R4 . . . ) one after another to cool the resin, and then
further cooling the resin while maintaining the resin in a flat state to solidify, and subsequently
withdrawing the resin by means of a pair of take-off rolls (N1, N2), wherein
the peripheral speed (V₃) of the one lattercooling roll (R3) or the average peripheral speed (V₃ₐ) of the plurality of the lattercooling rolls (R3, R4 . . . ) is made to be 0.94 times to 1.03 times the average peripheral speed (V₁₂) of the first cooling roll (R1) and the second cooling roll (R2),
the average peripheral speed (Vₙ) of the pair of the take-off rolls (N1, N2) is made to be 0.95 times to 1.03 times the peripheral speed (V₃)of the one lattercooling roll (R3) or the average peripheral speed (V₃ₐ) of the plurality of the lattercooling rolls (R3, R4 . . . ), and
the average peripheral speed (Vₙ) of the pair of the take-off rolls (N1, N2) is made to be 0.95 times to 0.995 times the average peripheral speed (V₁₂) of the first cooling roll (R1) and the second cooling roll (R2).

11. The process of claim 10, wherein the further cooling the resin while maintaining the resin in a flat state in conducted at an atmosphere of 35° C. or more to solidify.

12. The process of claim 10, wherein
the thickness of the extruded resin sheet (A) is from 0.8 mm to 5 mm.

13. The process of claim 10, wherein
the thermoplastic resin is a transparent resin (P).
